(19) United States
(12) Patent Application Publication
(10) Pub. No.: US 2014/0379365 A1
(43) Pub. Date: Dec. 25, 2014

(54) MEANINGFUL PRESENTATION OF HEALTH RESULTS TO DETERMINE NECESSARY LIFESTYLE CHANGES

(71) Applicant: KONINKLIJKE PHILIPS N.V., Eindhoven (NL)

(72) Inventors: LEONTIEN DE ROODE, Shanghai (CN); LEONIE FRANCELLE WAANDERS, Druten (NL); WENDY UYEN DITTMER, Eindhoven (NL); NAGARAJU BUSSA, Hyderabad (IN); VIKRAM BASAWARAJ PATIL OKALY, Bangalore (IN); MARCIA ALVES DE INDA, Rosmalen (NL); ARUN KUMAR MANI, Mayiladuthurai (IN)

(21) Appl. No.: 14/311,403

(22) Filed: Jun. 23, 2014

Related U.S. Application Data
(60) Provisional application No. 61/838,381, filed on Jun. 24, 2013.

(51) Int. Cl. G06F 19/00

(52) U.S. Cl. CPC G06F 19/3431; G06F 19/363
USPC 705/2

(57) ABSTRACT

A medical system (10) which presents consumer health results includes a consumer questionnaire unit (14), a workflow assistant (20), a risk assessor (26), a guideline interpreter (28), and a display device (36). The consumer questionnaire unit (14) identifies consumer habits based on received responses to personal, medical, and lifestyle questions. The workflow assistant (20) iteratively identifies medical tests for the consumer based on a rule based evaluation of responses and received medical test results. The risk assessor (26) calculates a health risk to the consumer based on the identified habits and lifestyle behaviors and received medical test results, and determines body damage to the consumer based on received medical test results. The guideline interpreter (28) constructs a lifestyle advice display based on the identified consumer habits, the calculated health risk, the determined body damage, and lifestyle advice. The display device (36) displays the lifestyle advice display.

The following relates generally to medical informatics. It finds particular application in conjunction with health risk assessment, patient testing, and lifestyle advisement, and will be described with particular reference thereto. However, it will be understood that it also finds application in other usage scenarios and is not necessarily limited to the aforementioned application.

Information available to a person or consumer about a health risk such as cardiovascular disease (CVD) is typically limited to fragmented discussions with a healthcare practitioner or an individual's research with the Internet. The discussions may include questions from the healthcare practitioner about the risk factors which enable the healthcare practitioner to determine appropriate tests to diagnosis a condition. Other discussions may include discussions about lifestyle changes such as changes to smoking habits, diet, and/or exercise habits based on current patient conditions. The person typically relies on the healthcare practitioner to order any tests the healthcare practitioner determines are appropriate often without further explanation. Many persons or consumers of healthcare services feel disconnected or removed from their healthcare decisions, and do not understand the relationship between risk assessment, physical status, and lifestyle changes.

Furthermore, the lifestyle changes proposed by the healthcare practitioner are typically generalized concepts without action steps. For example, advising a consumer to eat healthy foods to live longer is too general to be useful and is typically ignored. Consequently, consumers continue their usual behavior because the consumer does not understand or see a cognizable link between their personal lifestyle behaviors and the health risk. For example, a consumer who smokes may understand that people who smoke are at risk for CVD, but is likely not to understand how his/her continued smoking creates a risk for CVD or damages his/her body. As a result, the consumer is likely to continue smoking and/or continue other behaviors which contribute to the disease progression or increase their health risk.

The following discloses a new and more meaningful presentation of health results to determine necessary lifestyle changes system which addresses the above referenced issues, and others.

In accordance with one aspect, a medical system which presents consumer health results includes a consumer questionnaire unit, a workflow assistant, a risk assessor, a guideline interpreter, and a display device. The consumer questionnaire unit identifies consumer habits based on received responses to personal, medical, and lifestyle questions. The workflow assistant iteratively identifies medical tests for the consumer based on a rule based evaluation of responses and received medical test results. The risk assessor calculates a health risk to the consumer based on the identified habits and lifestyle behaviors and received medical test results, and determines body damage to the consumer based on received medical test results. The guideline interpreter constructs a lifestyle advice display based on the identified consumer habits, the calculated health risk, the determined body damage, and lifestyle advice. The display device displays the lifestyle advice.

In accordance with another aspect, a method of presenting health results to a consumer includes identifying consumer habits based on received responses to personal, medical and lifestyle questions. Medical tests for the consumer are iteratively identified based on a rule based evaluation of responses and received medical test results. The health risk to the consumer is calculated based on the identified consumer habits and received medical test results, and body damage is determined based on received medical test results. A lifestyle advice display is constructed based on the identified consumer habits, the calculated health risk, and the determined body damage. The lifestyle advice is displayed.

In accordance with another aspect, a medical system which presents health results to a consumer includes one or more processors, and a display device. The one or more processors are configured to identify habits and/or lifestyle behaviors of a consumer based on received consumer responses to personal, medical, and lifestyle questions, and calculate a health risk to the consumer based on the identified habits and/or lifestyle behaviors and received basic test results for the consumer. The one or more processors are further configured to construct a lifestyle advice display which includes the identified habits and/or lifestyle behavior, and calculated health risk. The display device displays the lifestyle advice.

One advantage is a stepwise presentation of medical test results to consumers and healthcare practitioners followed by actionable lifestyle advice.

Another advantage resides in simple and comprehensible presentation of test results to consumers.

Another advantage resides in the correlation of habits, lifestyle, and other factors with related risks and signs of body damage.

Another advantage resides in the user interface which progressively builds an understanding of the health risk and increases the acceptance of lifestyle changes advice.

Another advantage includes rule-based guidelines which structure and highlight paths between habits, risk, signs of damage, and lifestyle advice.

Another advantage is the linear time based display and interactive presentation of information based on personalized cause and effect relationships.

Another advantage is the flexibility to include healthcare practitioners in the discussion of health risks and lifestyle advice with a consumer or patient.

Still further advantages will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

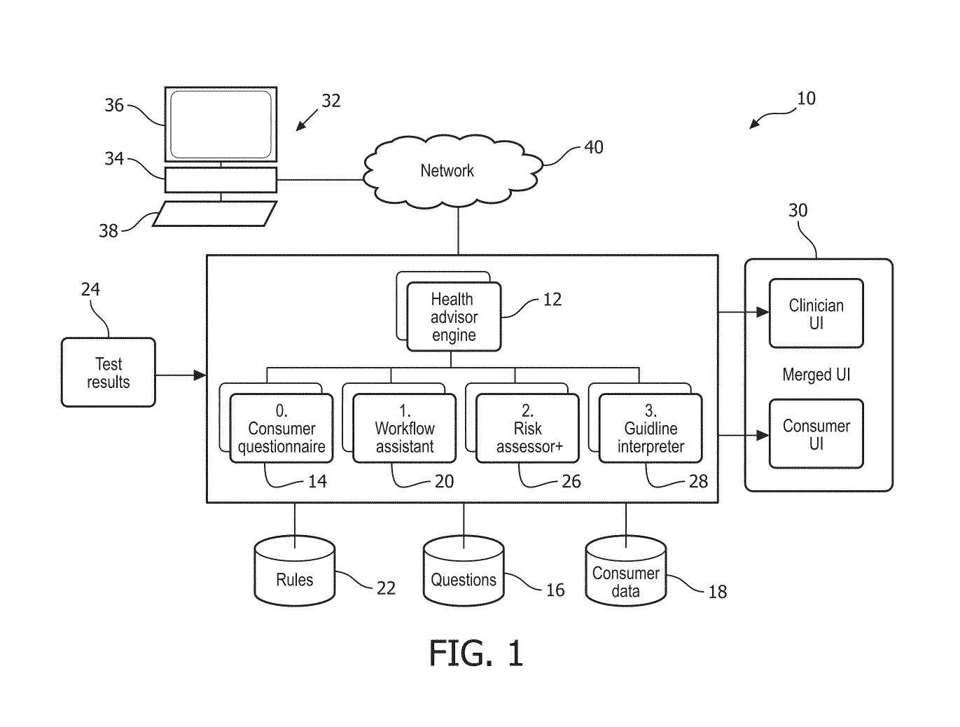

FIG. 1 schematically illustrates an embodiment of meaningful presentation of health results to determine necessary lifestyle changes system.

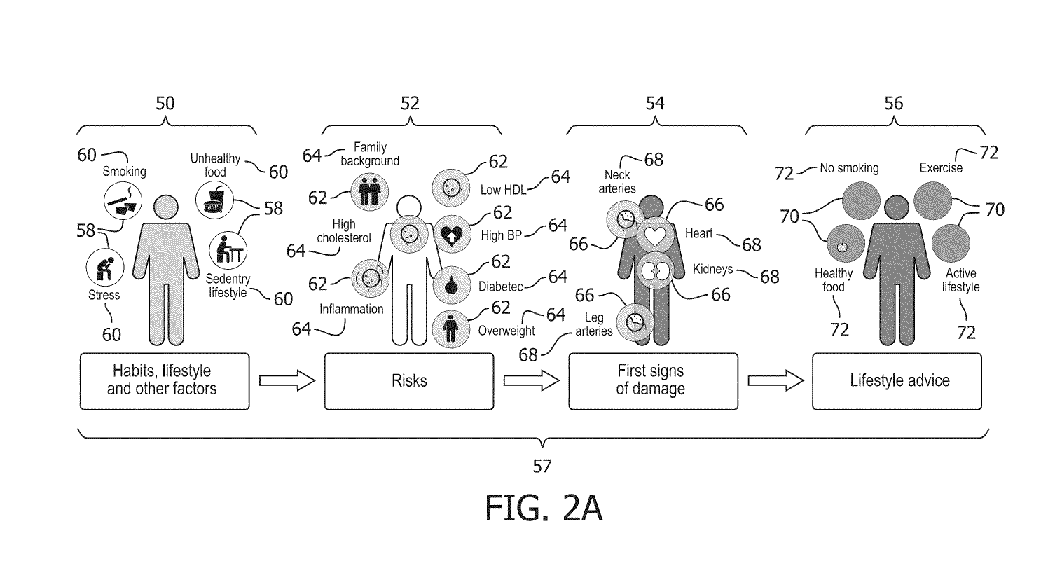

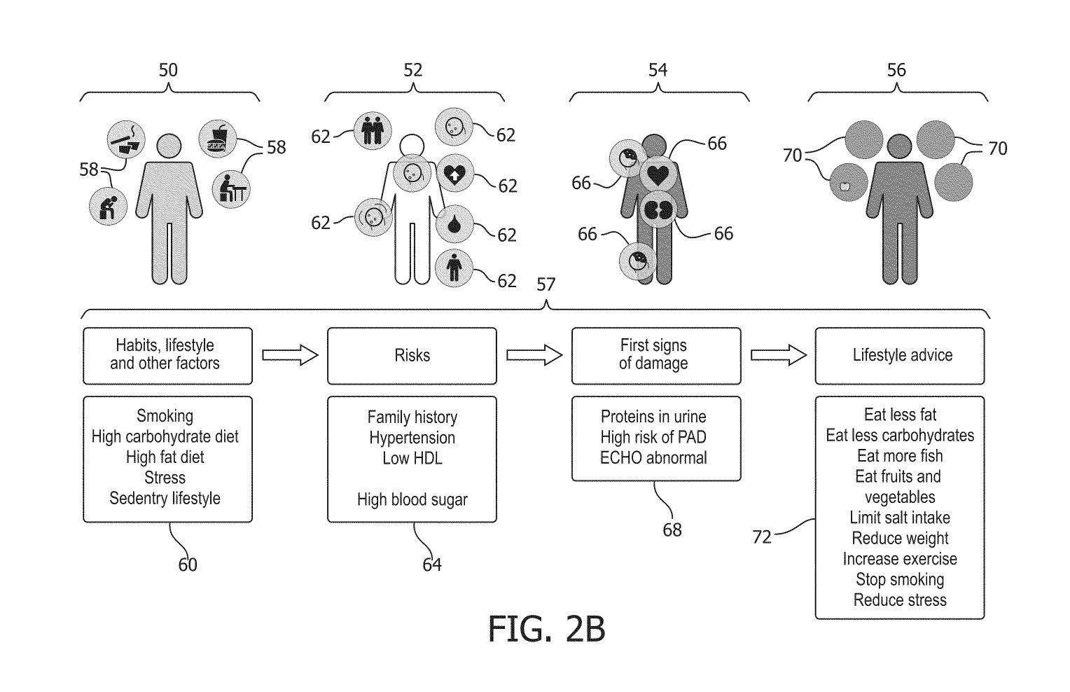

FIGS. 2A-2B illustrate exemplary displays of presented health results.

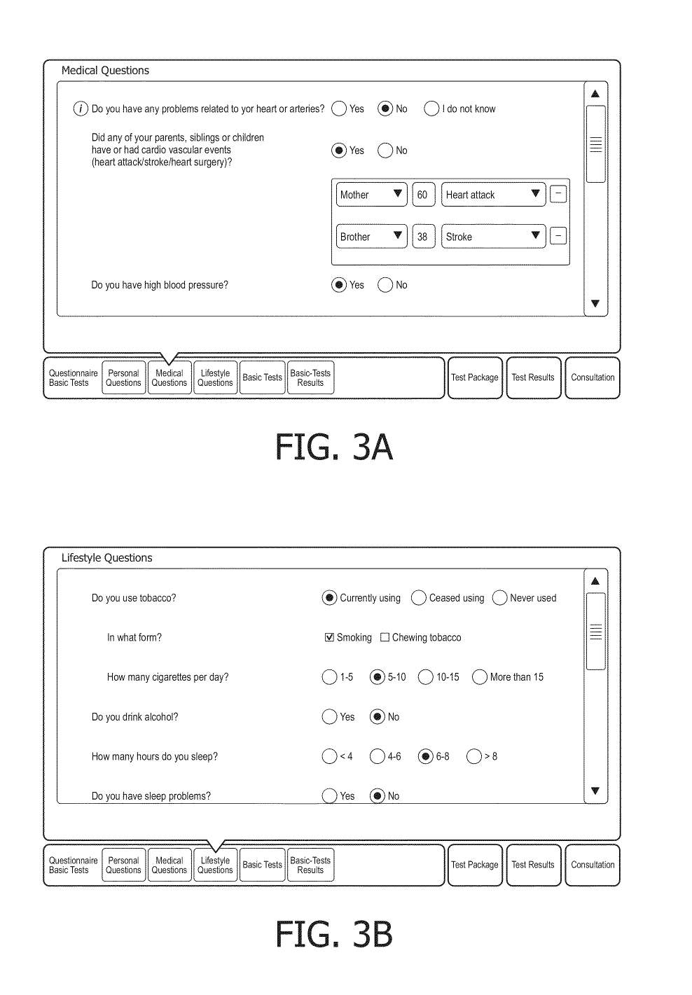

FIGS. 3A-3B illustrate exemplary displays of consumer questions.

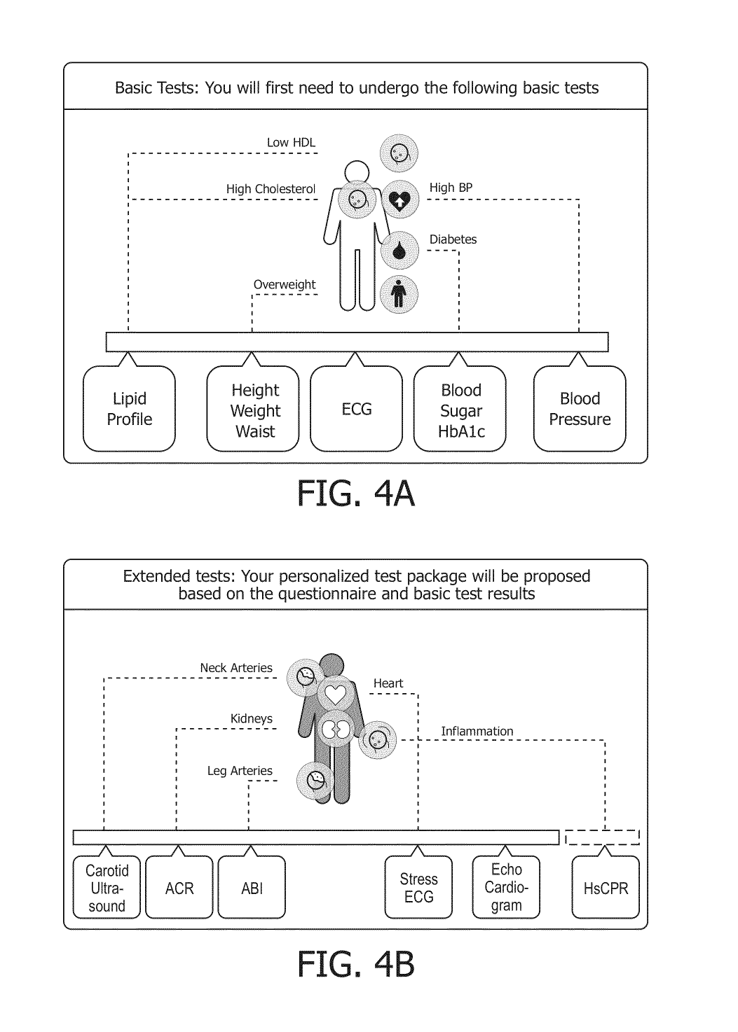

FIG. 4A-4B illustrate exemplary displays of iteratively identified medical tests.

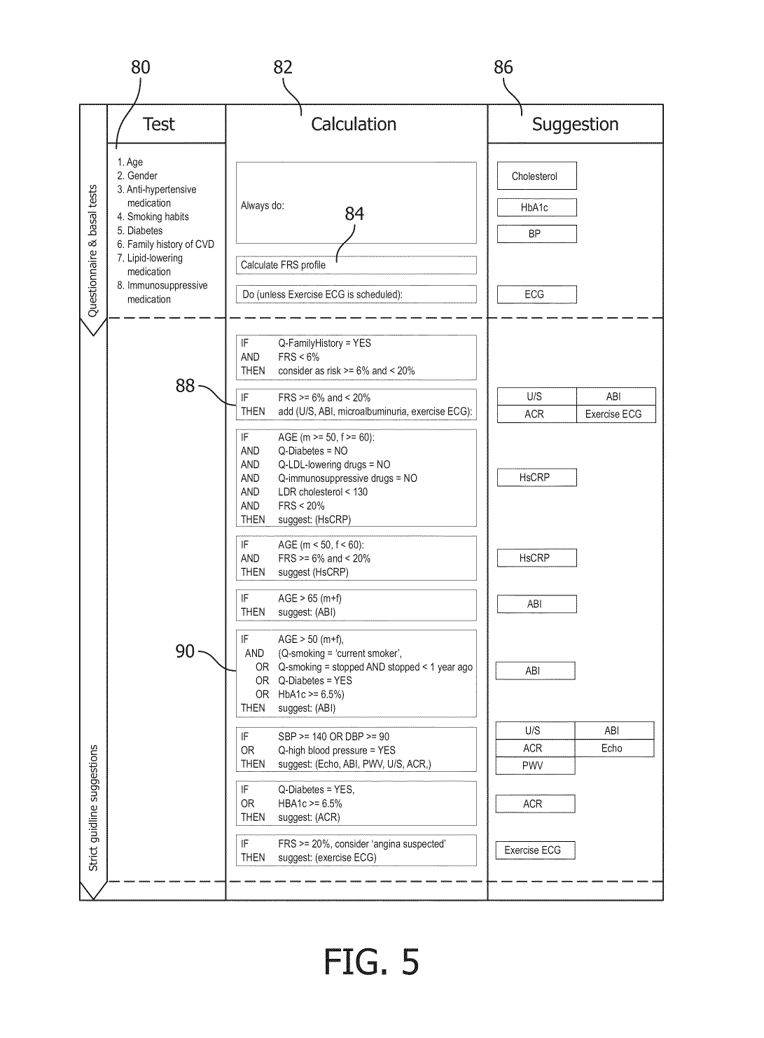

FIG. 5 graphically illustrates a rule based evaluation which iteratively identifies medical tests.

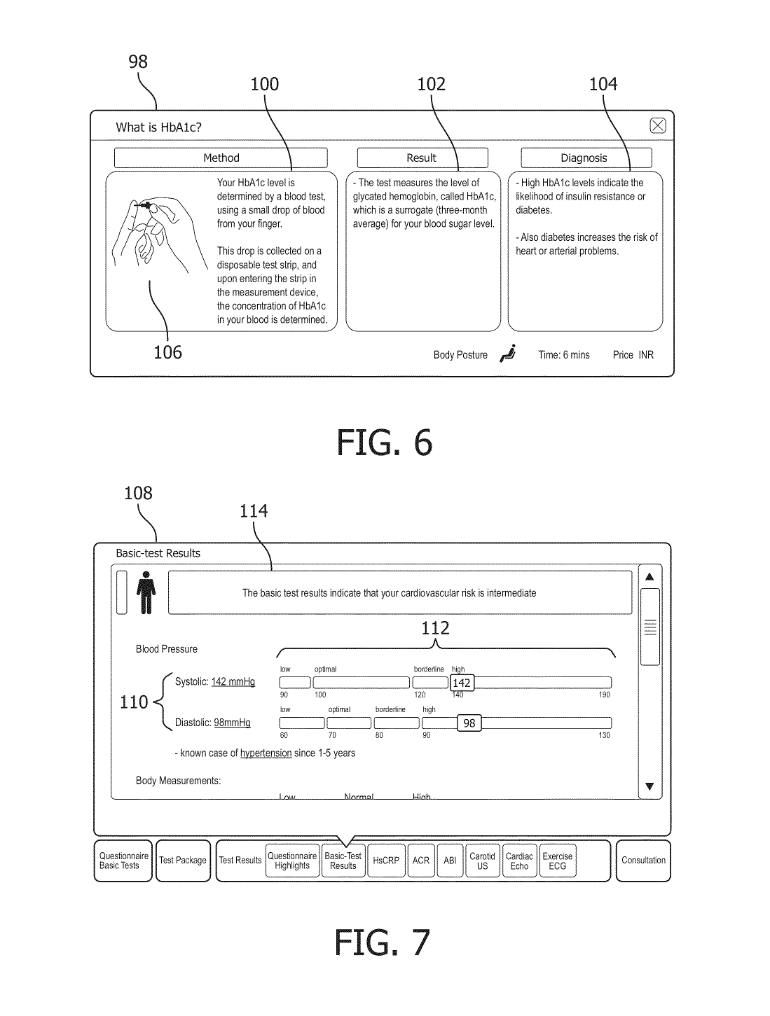

FIG. 6 illustrates an exemplary display of a medical test explanation.

FIG. 7 illustrates an exemplary display of a medical test result with a measured health risk.

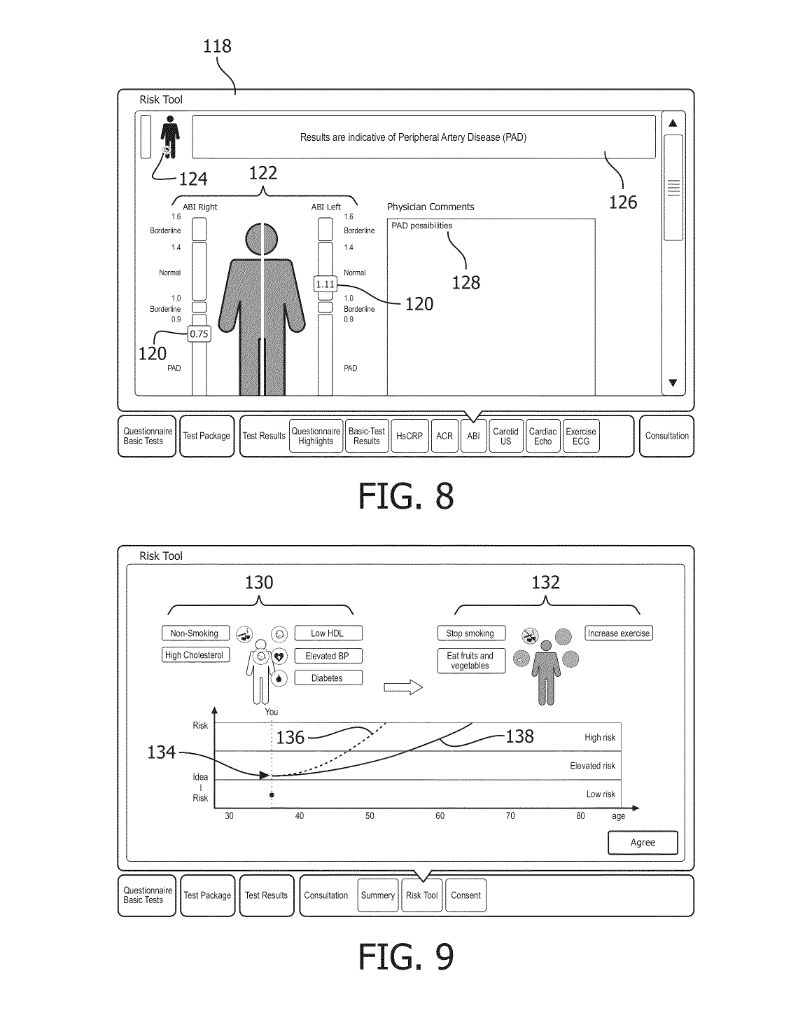

FIG. 8 illustrates an exemplary display of a medical test result with determined body damage.

FIG. 9 illustrates an exemplary display of a personalized risk tool.

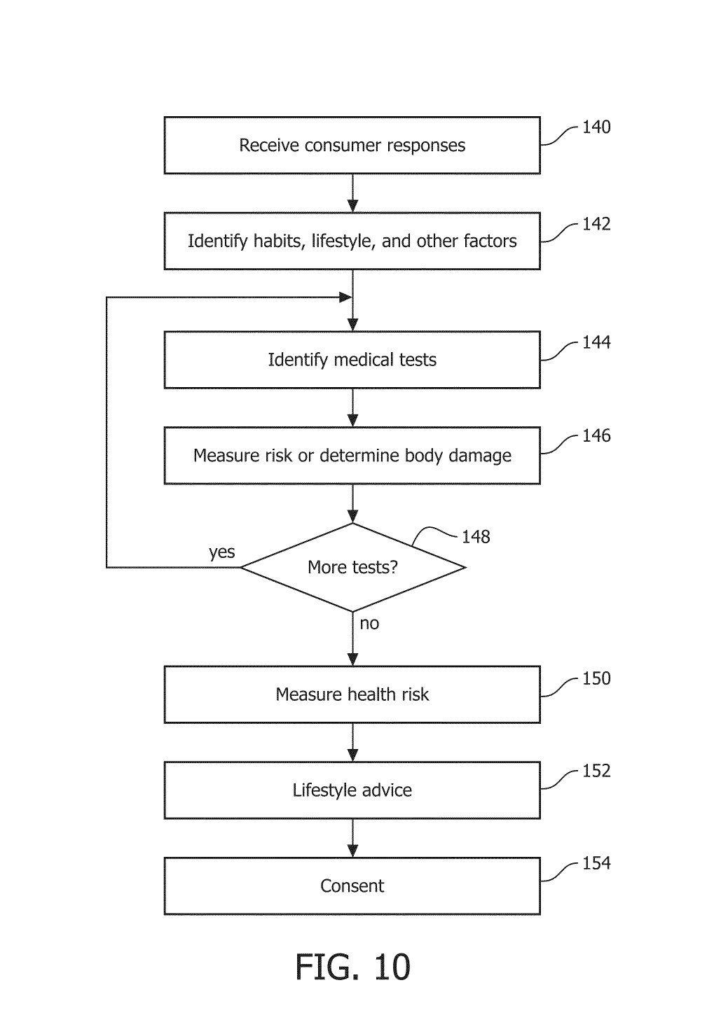

FIG. 10 flowcharts one method of using an embodiment of meaningful presentation of health results to determine necessary lifestyle changes.

With reference to FIG. 1, an embodiment of meaningful presentation of health results to determine necessary lifestyle changes system 10 is schematically illustrated. The system includes a health advisor engine 12 which coordinates the various units or modules with application flow and provides administrative services. The administrative services include login and authentication, security, consumer list maintenance and selection, database connectivity, alerts, notifications, and the like.

The system 10 includes a consumer questionnaire unit 14 which selects questions from a question data store 16 and receives responses. The questions include personal, medical, and lifestyle questions. The consumer questionnaire unit identifies habits and/or lifestyle behaviors based on the received responses. The identified habits and/or lifestyle behaviors include habits which include or contribute to risks or risk factors of a disease. The responses can be entered directly by the consumer and/or assisting healthcare practitioner, and/or collected from external sources electronically such as prior electronically stored consumer data. The received responses can be stored in a consumer data store 18.

The system includes a workflow assistant 20 which iteratively identifies medical tests for the consumer. The identified medical tests are identified based on a rule based evaluation of received responses and can include received medical test results. A healthcare practitioner and the consumer can discuss and decide together the final test package. The rules can be stored in a rule data store 22 such as a Structure Query Language (SQL), relational, or object-oriented database. The workflow assistant 20 receives medical test results 24 which can be stored in the consumer data store 18. The medical test results can be received by manual entry, manual transfer (e.g., USB thumb drive, flash drive, and the like), barcode scanner, network transfer (file transfer protocol (FTP) and the like), and/or direct interface to a medical testing device (wired or wireless). In a first iteration, the workflow assistant identifies basic medical tests which measure health risk. In a second iteration, the workflow assistant identifies additional medical tests which determine body damage in the body of the consumer. In the second iteration, the identification can be based on the measured health risk, results of the basic medical tests, and/or other information such as the received responses. The iterations can be further subdivided.

The system 10 includes a risk assessor 26 which measures a health risk based on the received responses and basic test results. The basic test results can include a single measurement such as blood sugar, or multiple measurements such as systolic blood pressure and diastolic blood pressure, or further combine several test results into one measure such as a combination of height, weight, and waist circumference as a measure of body fat. The measures can be quantified as levels such as low risk, intermediate risk, and high risk. The measures can be numerically based or further divided into finer discrete intervals based on the health risk measured. For example, a health risk of cardiovascular disease includes measurement of low, intermediate, and high risk. A measure of blood pressure which is abnormal or high is determinative or causal of an intermediate or a high risk of CVD dependent upon other basic tests and/or received responses. In another example, the risk of cardiovascular disease includes a numerical score such as a Framingham Risk Score. The risk assessor determines body damage to the body of the consumer based on received additional medical test results. The determination can include measurements from the basic test results, measured health risk and/or received responses.

The system includes a guideline interpreter 28 which constructs lifestyle advice displays based on the identified consumer habits and/or lifestyle behavior, the measured health risk, the determined and/or measured body damage, and the like. The display builds a gradual understanding for the consumer of the impact of the consumer habits on the consumer health risk with the combined display of habits, risk, damage, lifestyle advice, and the like. The display includes a personalized display of identified habits and/or lifestyle behaviors which are risk factors for the health risk. The display includes a personalized display of measured health risks and affected anatomy. The display includes a personalized display of determined body damage and related anatomy. The display includes a personalized display of lifestyle advice related to the determined health risks and body damage. The visual display includes graphical and text visualization. The display can include color highlights such as red for severe or high risk and/or significant body damage, yellow for intermediate risk and/or possible body damage, and green for low risk and/or no determined body damage. The display can include the affected anatomy or source for a measured risk such as heart, arteries, family history, etc. The display can include the location and/or body portion related to the determined body damage such as an organ shape and/or position the in the anatomy. For example, plaque in arteries can be shown as a narrowed artery located in a leg or neck.

The guideline interpreter 28 can construct displays of test results and/or displays of medical test explanations. The display of a test result includes the quantified test result, text, or numerical values, a graphical visualization of the test result, and a measure of the health risk, and the like. The graphical visualization of the test results includes indications of at least normal values and abnormal values, but may provide further delineations. Constructed displays of medical test explanations include an explanation of how the test is performed, an explanation of what is measured by the medical test, and an explanation of the health risk measured or body damage determined by the medical test. The explanation of how the test is performed can include graphical illustrations of how the test will be performed on the body of the consumer or the appearance of the testing process to the consumer.

The guideline interpreter 28 can construct a personalized visual display of life expectancy of the consumer based on the measured health risk and determined body damage. The display includes lifestyle advice. The display can be interactive, which allows the consumer to indicate lifestyle changes and the display modified to show the impact to life expectancy. The display includes the measured health risk for the consumer. The life expectancy can be indicated as a line graph, bar graph, and the like. The guideline interpreter can further include a consent process whereby the consumer indicates consent to identified changes in lifestyle such as selecting one or more displayed lifestyle advices with the input device.

The system includes a merged user interface 30 for both a clinician or healthcare practitioner and the consumer. The user interface 30 includes a computing device or workstation 32 such as a laptop, a tablet, a mobile computing device, a smartphone, and the like. The workstation 32 includes an electronic processor or electronic processing device 34, a display device 36 which displays the constructed displays, pop-up or explanation displays, medical test result displays, advice displays, menus, panels, and user controls, and at least one input device 38 which inputs the healthcare practitioner or consumer selections. The display may output visual, audio, and or tactile data. Examples of a display include, but are not limited to: a computer monitor, a television screen, a touch screen, tactile electronic display, Braille screen, Cathode ray tube (CRT), Flat panel display, Light-emitting diode (LED) displays, Electroluminescent display (ELD), Plasma display panels (PDP), Liquid crystal display (LCD), Organic light-emitting diode displays (OLED), and the like. The input device can be a keyboard, a mouse, a microphone, and the like.

The various units or modules 12, 14, 20, 26, 28 are suitably embodied by an electronic data processing device, such as the electronic processor, computer, or electronic processing device 34 of the workstation 32, or by a network-based server computer operatively connected with the workstation 32 by a network 40, or so forth. The user interface module 30 is suitably embodied by the workstation 32. Moreover, the questionnaire, workflow, risk assessment, and guideline interpretation techniques are suitably implemented using a non-transitory storage medium storing instructions (e.g., software) readable by an electronic data processing device and executable by the electronic data processing device to perform the disclosed questionnaire, workflow, risk assessment, and guideline interpretation techniques. The system can include a web (HTTP) server which delivers constructed displays to a web browser. The server and browser can be configured on the same workstation or computing device or on separate computing devices separated by the network. The network can include a public network (e.g. Internet), private network, or a combination. The network can be wired, wireless, or a combination. The network can be configured for data traffic, cellular traffic, or a combination. The data stores can include structured memory such as SQL databases, object oriented databases, file systems, combinations, and the like.

FIGS. 2A-2B illustrate exemplary displays of presented health results which are personalized to the consumer. The exemplary displays are health results for cardiovascular disease (CVD). The personalized displays are constructed by the guideline interpreter and include the identified habits 50, measured health risk 52, determined body damage 54, and lifestyle advice 56. The display can include a body shape representative of the consumer. The display includes both graphical and text visualizations of the habits, risks, body damage, and advice. The graphical and text visualizations promote understanding by the consumer or healthcare practitioner by accommodating different learning styles such as persons who are linguistically oriented and/or persons who are visually oriented. The graphical visualization can include icons. The icons can be color coded such as red, yellow, or green which provide relative and fast distinctions between the various icons. The icons can indicate the habit, risk source or affected anatomy, damaged anatomical shape and/or position in the body such as heart, kidney, etc., and type of lifestyle advice. The graphical and/or text visualizations can be used by the user interface to drill down to additional detail such as received responses, medical test results, and/or greater detail or explanation of lifestyle advice. The displays show a progressive relationship 57 between the habits, risks, body damage, and advice. The relationship is supported by the received responses and test results.

With reference to FIG. 2A, the graphical visualizations of habits 58 and text visualization of habits 60 are displayed co-located. The visualization of habits is based on the received responses for risk factors of cardiovascular disease. The visualized habits can include all habits or subsets which are positive habits, e.g. healthy habit, or negative, e.g. unhealthy habit. For example, a consumer who smokes has a negative habit or risk factor for cardiovascular disease. The consumer who exercises regularly has a positive habit or risk factor for cardiovascular disease. The display can include visualizations for smoking and exercise, or only smoking and not exercise. Similarly, the graphical visualizations of measured risks 62 and text visualization of measured risks 64 are co-located. The text or graphical visualization of measured risk can be located in the display relative to the affected anatomy. For example, the visualization can be located near an organ or portion of anatomy associated with the risk, e.g. heart for heart attacks, hands for swelling, etc. The graphical visualizations of determined body damage 66 and text visualizations of determined body damage 68 can be co-located and located relative to the related anatomy, e.g. damaged or measured anatomy. For example damage measured to the arteries in the legs using an ankle-brachial index test are located near an ankle. In another example, where body damage is determined to the arteries of the neck using a carotid ultrasound test, the visualizations are located near the neck of the consumer body representation. The icons can be used to visually indicate the type of determined body damage such as narrowing of the arteries. The lifestyle advice graphical visualizations 70 and the text visualizations 72 can be co-located. The visualizations can include affirmation of existing habits or behaviors such as regular exercise, non-smoking, etc. with recommended changes in lifestyle. Alternatively, the visualizations can include only changes to lifestyle or habits such as changing exercise habits, changing to non-smoking, etc. With reference to FIG. 2B, the graphical visualizations and text visualizations are separated. The separation can reduce the size of the display and/or allow partitioning of the display for different display device configurations. In FIG. 2B, the graphical visualizations of habits 58 are located around the body representation of the consumer, while the text visualization of habits 60 is located separately and below. The configuration can be a system parameter and/or user preference. Similar separation for shown for graphical visualizations of measured risks 62 and text visualization of measured risks 64, graphical visualizations of body damage 66 and text visualization of body damage 68, and graphical visualizations of lifestyle advice 70, and text visualization of lifestyle advice 72.

FIGS. 3A-3B illustrate exemplary displays of medical and lifestyle consumer questions for health risk assessment of cardiovascular disease. Displays of personal questions can be constructed similarly and/or include populated responses to questions such as age and gender confirmed by the consumer. The populated responses can be supplied from consumer data entered by others and/or received in the consumer data store 18. The medical and lifestyle questions are specific for the health risk such as risk of cardiovascular disease. The questions can be retrieved from the question data store 16 and the display dynamically constructed, and/or the displays retrieved from the question data store pre-configured with the questions such as a web page, page frame, etc. The display can be scrolled. The responses can be received via the input device with radio buttons, drop down boxes, text boxes, check boxes, and the like. The received responses are stored in the consumer data store 18. In one embodiment, medical and/or lifestyles questions can be populated from the medical records or other sources for the consumer. With reference to FIG. 3A, medical questions for risk of cardiovascular disease can include family history questions such as “Did any of your parents, siblings, or children have or had cardio vascular events (heart attack/stroke/heart surgery)?” or “Do you have high blood pressure?”. With reference to FIG. 3B, lifestyle questions can include habits such as tobacco use, alcohol consumption, sleep, etc. For example, tobacco use questions can include “Currently using tobacco?”, “Ceased using tobacco?”, or “Never used tobacco?”. Responses can further modify the displayed questions with responses such as with current using or ceased using responses which expand the display to include questions of quantity and/or duration of use.

FIG. 4A-4B illustrate exemplary displays of iteratively identified medical tests. The workflow unit identifies basic medical tests shown in FIG. 4A. The display includes the medical tests to be performed, and the risks to be measured. The basic tests for cardiovascular disease include measures of cholesterol, blood sugar, blood pressure, body fat, and/or resting ECG. The test for body fat is based on measurement of body mass index (BMI) such as calculated from height, weight, and waist circumference. Other comparable medical tests can be substituted based on the culture, medical devices available, and or site requirements. An ECG medical test can be included based on the received responses, while tests for cholesterol, blood sugar, blood pressure, and body fat are always performed and such tests are typically part of normal healthcare screening. The display relates the medical tests to the health risk. For example, a lipid profile or cholesterol test can provide measures of low HDL and/or high total cholesterol. The risk can include a graphical illustration such as a narrowed artery icon and text such as “Low HDL” or “High Cholesterol”. The displayed medical test can include what is measured, e.g. blood sugar, and/or the name of the test, e.g. HbA1c. The display can permit the consumer to drill down or receive a pop-up explanation of the test. The display can be modified to show completed tests different from pending tests.

With reference to FIG. 4B additional medical tests identified in a second iteration by the workflow assistant unit 20 includes medical tests based on the results of the first iteration or basic medical test results, and the received responses by the questionnaire unit 14. Additional medical tests to determine body damage from cardiovascular disease can include carotid ultrasound, ACR, ABI, stress ECG, Echo, HsCRP, and the like. The display can include differentiating proposed tests, completed tests, and/or possible tests. The differentiating can include color coding and/or modifying the displayed test such as adding a check mark or otherwise indicating a different status.

FIG. 5 graphically illustrates a rule based evaluation embodiment of the workflow assistant 20 which iteratively identifies medical tests for a CVD health risk. In a first iteration based on received responses 80 include age, gender, anti-hypertensive medication, smoking habits, diabetes, family history of CVD, lipid-lowering medication, and immunosuppressive medication. The rules 82 include a calculation of a Framingham risk score (FRS) 84. The rules 82 suggest or identify medical tests 86. The first iteration, which the rule indicates to always do, includes medical tests which measure cholesterol, blood sugar (HbA1c), and blood pressure. An ECG is always performed unless an Exercise ECG is scheduled. The rules can suggest additional tests. For example, a rule 88 evaluates the Framingham Risk Score between 6 and 20% suggests carotid ultrasound, ACR, ABI, and Exercise ECG medical tests. In example iterative rule 90, an ABI medical test can be added as an additional test, if the blood sugar test result from the blood sugar (HbA1c) basic test exceeds 6.5%. The rules 82 are stored in the rules data store 22.

FIG. 6 illustrates an exemplary display of a medical test explanation 98. The display can be presented to the consumer as a pop-up display to the displays described in reference to FIGS. 4A-4B selected by the consumer with the input device by clicking on the test name. The test explanation includes an explanation in consumer language of how the medical test is performed 100, an explanation of what is measured by the medical test 102, and an explanation of the health risk measured or body damage determined 104 by the medical test. The display of the medical test explanation 98 can include a graphical illustration of how the test is performed 106. In the example, a HbA1c medical test which measures blood sugar includes an explanation of how the test is performed related to the consumer such as “Your HbA1c level is determined by a blood test, using a small drop of blood from your finger.” The explanation explains what will be needed from the consumer. The explanation further includes “This drop is collected on a disposable test strip, and upon entering the strip in the measurement device, the concentration of HbA1c in your blood is determined” The further explanation explains how the medical test will be performed using the drop of blood from the consumer to determine the measured result. The illustration 106 shows the pricking of a finger to extract a drop of blood.

The explanation of what is measured by the test 102 includes an explanation of the results of a test. In the example, the HbA1c test explanation of what is measured includes “The test measures the level of glycated hemoglobin, called HbA1c, which is a surrogate (three-month average) for your blood sugar.” The explanation explains what is being measured relative to the consumer which in this example is blood sugar.

The explanation of the measured health risk or determined body damage 104 includes possible diagnosis. For example, the HbA1c medical test explanation includes “high HbA1c levels indicate the likelihood of insulin resistance or diabetes” and “also diabetes increases the risk of heart or arterial problems”. The explanations show a linear and progressive relationship between the drop of blood taken from the consumer, measured for blood sugar, and the risk of heart or arterial problems indicated diabetes suggested by high levels of blood sugar. The medical test explanations can include other information of concern to the consumer such as the time to perform the test, the cost, and/or body posture to take the test.

FIG. 7 illustrates an exemplary display of a basic medical test result 108. The medical test result includes a text visualization 110 and a graphical visualization 112 of the test result. For example, the text visualization of a blood pressure test result includes systolic and diastolic pressure measurements in mm of Hg. The graphical visualization represents normal and abnormal test results. For example, the systolic is normal or optimal in the 100-120 range. The systolic pressure is high or abnormal above 140. Ranges can be further delineated such as low, e.g. below 100, and borderline, e.g. between 130 and 140. The test result display can include received question responses or other medical data such as consumer history or medical record data relevant to the medical test. In the example, the consumer has a known case of hypertension for 1-5 years. The medical test result includes a calculated measure of the health risk 114, which is a summary to explain the influence the test result has on a consumer's health risk. In the example, with a blood pressure of 142/98, the calculated health risk of cardiovascular disease is intermediate.

FIG. 8 illustrates an exemplary display of an additional medical test result 118 which measures and/or determines body damage. The example measures arterial damage to arteries of the ankles, particularly the ankle brachial index (ABI). The medical test result determines body damage from peripheral artery disease. The medical test result display includes a text visualization 120 and a graphical visualization 122 of the medical test result. The display can include the related anatomy 124 examined by the medical test. In the example, a display of the location of the ankles is graphically illustrated. The display includes determined body damage 126 such as a result indicative of peripheral artery disease. The display can include further explanation or interpretation by a healthcare practitioner 128.

FIG. 9 illustrates an exemplary display of a personalized risk tool. The display can include a summary of the consumer measured risks 130, resulting lifestyle advice 132, and includes the measured health risk 134 and consumer life expectancy 136. The display of life expectancy is based on the measured risks and determined body damage. The consumer life expectancy can be illustrated as a line graph, bar graph, and the like. In the example, age of the consumer is shown on the horizontal axis and measured risk level of cardiovascular disease on the vertical axis. The current age of the consumer is shown with a vertical line and the risk of the consumer for cardiovascular disease shown as a line which increases with age. In the example, the measured risk of CVD is intermediate for the current age of the consumer.

The display can include interactive changes that modify the display of life expectancy of the consumer based on lifestyle changes. For example, in a discussion with the physician, the consumer selects lifestyle advices such as “increase exercise”, and “eat fruits and vegetables” using the input device, e.g. clicking on the visual representation of the corresponding lifestyle advices. The display presents an alternative life expectancy 138 based on the lifestyle advice selected. The display can include a consent process by the consumer to the lifestyle advice with the selected lifestyle advices, e.g. selecting a button which indicates agreement to the changes.

FIG. 10 flowcharts one method of using an embodiment of meaningful presentation of health results to determine necessary lifestyle changes. In a step 140, the responses to the personal, medical, and lifestyle questions are received by the consumer questionnaire unit 14. Consumer habits or lifestyle behaviors are identified which identify or contribute to risk factors for a health risk of a disease in a step 142.

The workflow assistant 20, in a step 144, iteratively identifies medical tests for the consumer based on a rule based evaluation of the received responses and received medical test results. The medical test results are received in a step 146, and either measure risk and/or determined body damage. A decision step 148, returns to iteratively identify additional tests. A first iteration identifies basic tests which measure risk or risk factors. The first set of tests, the basic tests such as cholesterol, HbA1c, BP, ECG, include a fixed set of tests common to all consumers. Additional iterations can add additional tests specific to the consumer which determine body damage. The additional tests are identified based on the received responses and/or received medical test results. The received responses and/or received test results can be used to calculate a quantified risk score of a disease such as the Framingham Risk Score for CVD. The quantified risk score can be used to further identify additional medical tests.

A measure of the health risk is calculated in a step 150 by the risk assessor 26 based on the received responses and received medical test results. A display lifestyle advice is constructed with consumer life expectancy and lifestyle advice which can improve or mitigate the measured health risk in a step 152. The display is constructed by the guideline interpreter 28. The display is displayed by the display device 36. The display can be interactive with selection of each lifestyle advice by the consumer and modifying the display of consumer life expectancy accordingly.

In a step 154, the consumer indicates consent to lifestyle advices displayed. The consent can include additional displays such as reformatting, printing and/or emailing lifestyle advices selected, and/or not selected. Consent can also include measured medical test results and/or further follow-up. Means can be provided for performing steps 140-154 such as a computer or electronic processing device.

It is to be appreciated that in connection with the particular illustrative embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof. That is to say, it will be appreciated that various of the above-disclosed and other features and functions, or alternatives thereof, may be desirably combined into many other different systems or applications, and also that various presently unforeseen or unanticipated alternatives, modifications, variations or improvements therein may be subsequently made by those skilled in the art which are similarly intended to be encompassed by the following claims.

What is claimed is:

1. A medical system (10) which presents consumer health results, comprising:
a consumer questionnaire unit (14) which identifies consumer habits based on received responses to personal, medical, and lifestyle questions;
a workflow assistant (20) which iteratively identifies medical tests for the consumer based on a rule based evaluation of responses and received medical test results;
a risk assessor (26) which calculates a health risk to the consumer based on the identified habits and lifestyle behaviors and received medical test results, and determines body damage to the consumer based on received medical test results;
a guideline interpreter (28) which constructs a lifestyle advice display based on the identified consumer habits, the calculated health risk, the determined body damage, and lifestyle advice; and
a display device (36) which displays the lifestyle advice display.

2. The system according to claim 1, wherein a first iteration by the workflow assistant (20) identifies basic medical tests; and wherein the risk assessor (26) calculates the health risk based on the received results of the identified basic medical tests.

3. The system according to either one of claims 1 and 2, wherein a second iteration by the workflow assistant (20) identifies additional medical tests which determine body damage.

4. The system according to any one of claims 1-3, wherein the lifestyle advice display includes a graphical display of life expectancy of the consumer based on the calculated health risk and determined body damage.

5. The system according to claim 4, wherein the visual display of life expectancy includes interactive changes that modify the display of life expectancy of the consumer based on lifestyle advice.

6. The system according to any one of claims 1-5, wherein the lifestyle advice display includes a personalized display of identified consumer habits that are risk factors for the health risk, calculated health risk and affected anatomy, determined body damage and related anatomy, and lifestyle advice.

7. The system according to claim 6, wherein the lifestyle advice display includes a graphical representation and text for each identified habit, a graphical representation and text for each calculated health risk, a graphical representation and text for determined body damage, and a graphical representation and text for lifestyle advice.

8. The system according to any one of claims 1-7, wherein the workflow assistant (20) further includes for each medical test: an explanation of how the medical test is performed, an explanation of what is measured by the medical test, and an explanation of the health risk or body damage determined by the medical test result;
wherein guideline interpreter (28) constructs a display of the explanations; and
wherein the display device (36) displays the display of the explanations.

9. The system according to any one of claims 1-8 wherein the guideline interpreter (28) constructs a display of the received medical test result which includes a graphical representation and text of the medical test result and the measured health risk or the determined body damage; and
wherein the display device (36) displays the display of the received medical test result.

10. The system according to any one of claims 1-9, wherein the health risk includes cardiovascular disease (CVD);
wherein the received responses include: age, gender, family history of CVD, diabetes, smoking habits, antihypertensive medication, and immunosuppressive medication;
wherein medical test results include measures of at least one of: cholesterol, blood sugar (HbA1c), blood pressure, or resting ECG; and
wherein the rule based evaluation includes a Framingham risk score (FRS).

11. A method of presenting health results to a consumer, comprising:
identifying (142) consumer habits based on received responses to personal, medical and lifestyle questions;
iteratively identifying (144) medical tests for the consumer based on a rule based evaluation of responses and received medical test results;
calculating (150) the health risk to the consumer based on the identified consumer habits and received medical test results, and determining body damage based on received medical test results; and
constructing (152) a lifestyle advice display based on the identified consumer habits, the calculated health risk, and the determined body damage; and
displaying (154) the lifestyle advice display.

12. The method according to claim 11, wherein a first iteration identifies a fixed set of medical tests which measure the health risk.

13. The method according to either one of claims 11 and 12, wherein a second iteration identifies additional medical tests which determine body damage.

14. The method according to any one of claims 11-13, wherein the lifestyle advice display includes a visual display of life expectancy of the consumer based on the measured health risk and determined body damaged.

15. The method according to claim 14, further including:
interactively changing the display of life expectancy of the consumer based on lifestyle advice.

16. The method according to any one of claims 11-15, wherein the lifestyle advice display includes a personalized display of identified consumer habits which are risk factors for the health risk, calculated health risks and affected anatomy, determined body damage and related anatomy, and lifestyle advice.

17. The method according to any one of claims 11-16, further including:
displaying the received medical test result which includes a graphical representation and text of the medical test result and the calculated health risk or determined body damage.

18. A non-transitory computer-readable storage medium carrying software which controls one or more electronic data processing devices (34) to perform the method according to any one of claims 11-17.

19. An electronic data processing device (34) configured to perform the method according to any one of claims 11-17.

20. A medical system (10) which presents health results to a consumer, comprising:
one or more processors (34) configured to:
identify (142) habits and/or lifestyle behaviors of a consumer based on received consumer responses to personal, medical, and lifestyle questions;
calculate (150) a health risk to the consumer based on the identified habits and/or lifestyle behaviors and received basic test results for the consumer; and
construct (152) a lifestyle advice display which includes the identified habits and/or lifestyle behavior, and calculated health risk; and
a display device (36) which displays the lifestyle advice display.
